(19) United States
(12) Patent Application Publication
(10) Pub. No.: US 2010/0145987 A1
(43) Pub. Date: Jun. 10, 2010

(54) SYSTEM FOR AND METHOD OF LOCATION-BASED PROCESS EXECUTION

(75) Inventors: Craig Harper, Berkeley, CA (US); Vincent Sheffer, San Francisco, CA (US); Vytas SunSpiral, San Francisco, CA (US)

Correspondence Address: HAVERSTOCK & OWENS LLP, 162 N WOLFE ROAD, SUNNYVALE, CA, 94086, US

(73) Assignee: APISPHERE, INC., Berkeley, CA (US)

(21) Appl. No.: 12/631,378

(22) Filed: Dec. 4, 2009

Related U.S. Application Data
(60) Provisional application No. 61/200,950, filed on Dec. 4, 2008.

(51) Int. Cl. G06F 17/30; G06F 15/16; G06G 7/78

(52) U.S. Cl. 707/770; 709/204; 701/200; 707/E17.11; 707/E17.032; 707/769

(57) ABSTRACT

In accordance with the embodiments, when a device carried with a user enters a zone, Web content associated with that zone is dynamically generated and sent to the user's cell phone, portable computer, or other device capable of displaying the content. Content can include traffic conditions for travel routes through the zone, alternate travel routes, sales for stores located in or around the zone, and weather reports for the zone. The location and movement of the device is tracked by using cellular network towers, GPS components, WiFi locators, or any combination of these. In other embodiments, the location or movement triggers a control signal to be sent to a device, for example, to turn it on as a vehicle being tracked nears its destination.

### RELATED APPLICATION

This application claims priority under 35 U.S.C. §119(e) of the co-pending U.S. provisional patent application Ser. No. 61/200,950, filed Dec. 4, 2008, and titled “A System for Location Based Process Execution,” which is hereby incorporated by reference.

### FIELD OF THE INVENTION

The present invention relates to location-aware devices. More specifically, the present invention relates to location-based messaging and process execution.

### BACKGROUND OF THE INVENTION

Commuters have a difficult time performing multiple or repetitive tasks while traveling. This is true even for those with portable Internet-capable devices, which cannot be used safely while driving. For example, a commuter cannot easily look up traffic conditions for his drive home. Later, as he travels through a shopping district, he cannot easily check sale prices for watches sold by local merchants. He may not even remember stores in the area that he recently visited or items he bought there, two things that could make his search easier. As he approaches home, he cannot easily turn on a heater in his house just before he arrives. To do any of these tasks, he must manually perform an Internet search, generally performing multiple searches before finding the information he wants; he must call local stores for their sale items; and he must generate a control signal to remotely turn on the heater. He may perform different ones of these tasks each time he enters a neighborhood, city, or other region. These tasks are time consuming, inefficient, and, for drivers in busy traffic, dangerous.

### SUMMARY OF THE INVENTION

In a first aspect of the invention, a system includes a location module for tracking a location of an object and a computer-readable medium containing computer-executable instructions for executing a process corresponding to the location or any changes to it and for transmitting content determined by the process to a destination. The destination can be a mobile phone number, an email or short message service (SMS) address, or an Internet address. The object can be a cellular telephone, a GPS-enabled device, or a personal computer, to name only a few objects.

In one embodiment, the system also includes a first database that correlates different locations to different processes and a search module programmed to generate content, such as by performing database or Internet search queries. The content includes dynamically generated information such as a travel advisory related to the location, a travel route related to the location, alternate travel routes related to the location, a map related to the location, a list of merchants within a predetermined distance of the location, or any combination of these.

In one embodiment, the computer-executable instructions trigger the process when the object enters or leaves a pre-defined zone.

The system also includes a second database correlating an object (and thus a user) to purchases, a travel history, a travel plan, or any combination of these. The system is programmed to generate content based on elements in the second database, as well as on a time, a date, weather conditions, traffic conditions, crime reports, market reports, or any combination of these.

In a second aspect of the invention, a method includes tracking a presence of an object within any of multiple zones and communicating with a device based on the presence or any changes to it. In different embodiments, the device is sent rich media content, a voice message, audio content, video content, Web content, an email or an SMS message, a command to control the device, or any combination of these. Commands can be used to initiate a telephone call or to turn a device on or off, to name only two uses.

In one embodiment, an address (e.g., telephone number) of the device is determined dynamically, such as by accessing a contacts list or by determining what number to call based on the time of day, a zone entered, a zone exited, or any combination of these.

### BRIEF DESCRIPTION OF THE DRAWINGS

FIGS. 1A-C illustrate transmitting dynamically generated content and a control signal based on a location of a car, in accordance with one embodiment of the present invention.

FIG. 2 shows different configurations of zones used to track the location of an object, in accordance with one embodiment of the present invention.

FIG. 3 illustrates zones and a road network when delivering traffic incident warnings to motorists based on their location, in accordance with one embodiment of the present invention.

FIG. 5 shows a database defining zone boundaries, in accordance with one embodiment of the present invention.

FIG. 4 shows a database correlating zones with processes, in accordance with one embodiment of the present invention.

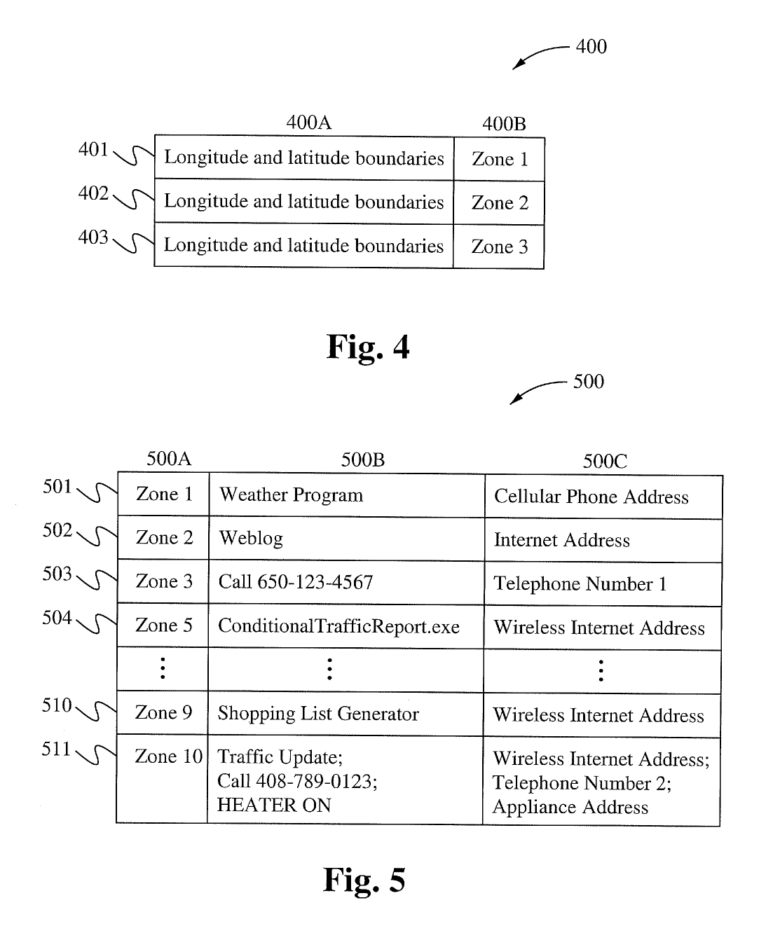

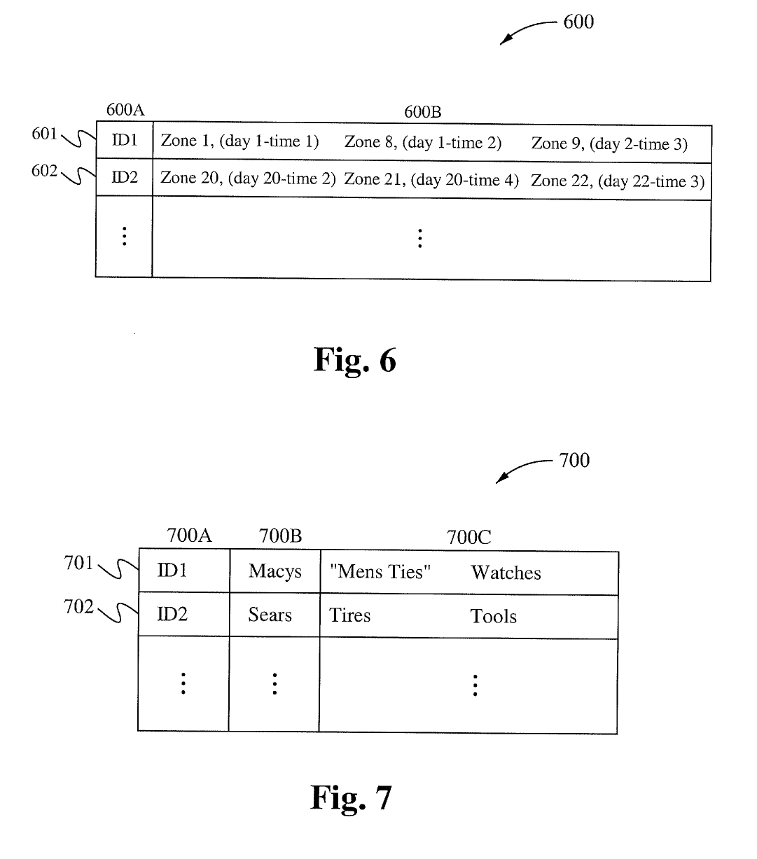

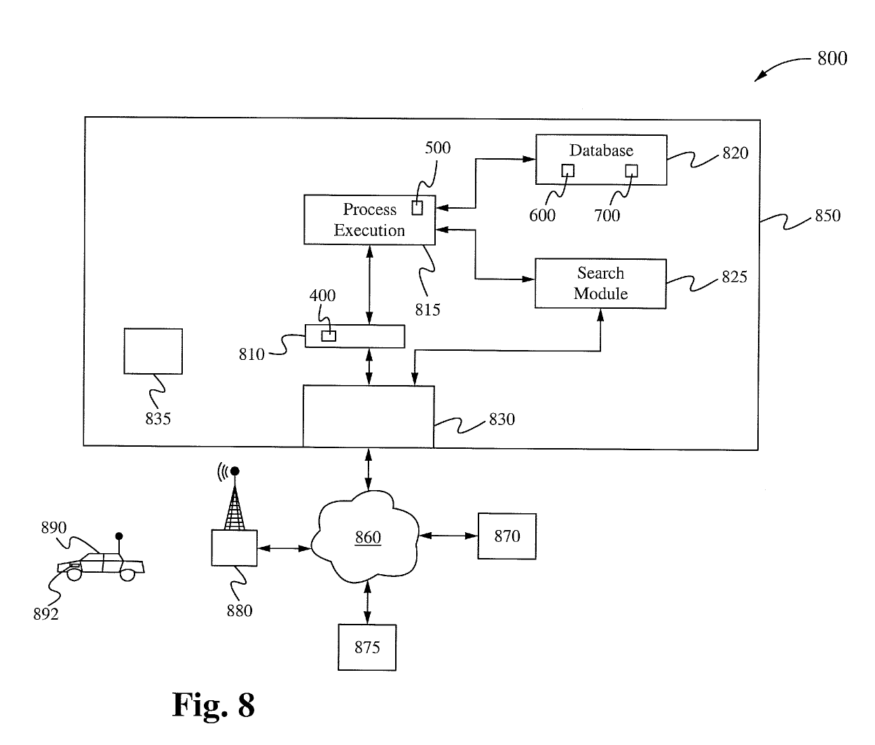

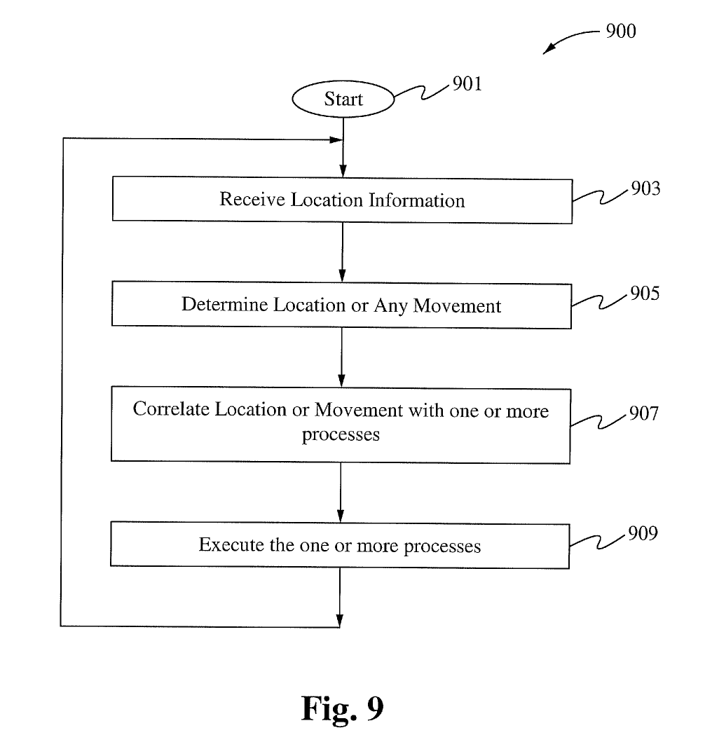

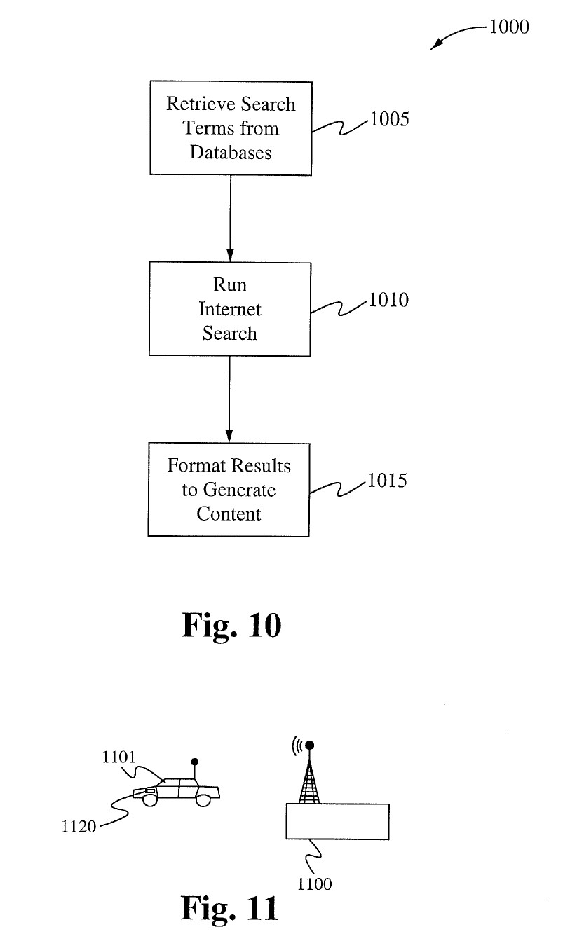

FIG. 5 shows a database correlating zones with processes, and processes with destinations, in accordance with one embodiment of the present invention.

FIG. 6 shows a database correlating device identifiers with travel histories, in accordance with one embodiment of the present invention.

FIG. 7 shows a database correlating device identifiers with shopping histories, in accordance with one embodiment of the present invention.

FIG. 8 shows a location server, in accordance with one embodiment of the present invention.

FIG. 9 shows the steps of a process executed by a location server, in accordance with one embodiment of the present invention.

FIG. 10 shows the steps of a process for dynamically generating content, in accordance with one embodiment of the present invention.

FIG. 11 shows a location server, in accordance with one embodiment of the invention.

### DETAILED DESCRIPTION OF THE EMBODIMENTS

In accordance with embodiments of the present invention, a system executes dynamic processes, such as the delivery of dynamically generated media, when a location-aware device satisfies defined relationships (such as inclusion, exclusion, entry, exit, etc.) with a geographical area defined within the system, referred to as “zones.” As one example, when a user enters a city, he receives on his cell phone dynamically generated content listing upcoming movie times in that city; when he enters another city, he receives dynamically generated content about traffic conditions in that other city.

The execution of the process and the content of any associated media or message can be influenced by a number of factors, such as:
History of other zones visited by the device, which may be concentric, intersecting, or fully disjoint, from the current zone.
Specific knowledge about the device and any associated assets or people, such as preferences, demographics, shopping history, schedule, commonly visited locations, and asset ID.
Other contextual knowledge about why the device and/or current user of the device is in the current and/or past and/or expected future zones.
Other knowledge taken from other private or public data sources, such as traffic data, time of day, weather, economic data, local businesses, and crime reports.
The time that has elapsed since the process was last executed.

In some embodiments, the processes triggered by the device's location interact with other devices or machines, such as delivering dynamic messaging to an email address, updating a Web page, delivering data directly to the device, initiating a phone call, activating a mechanical device, or recording data in a database.

One embodiment of the present invention includes one or more location-aware devices capable of communicating their location to a location server, one or more location servers, which compare incoming location information and other information provided by the device against one or more databases to determine which, if any, processes should be executed, an extensible database of geographically defined zones, an extensible library of processes, and a search module, which executes search queries to gather the appropriate data from local, remote, or third-party data sources in order to generate content for the triggered process.

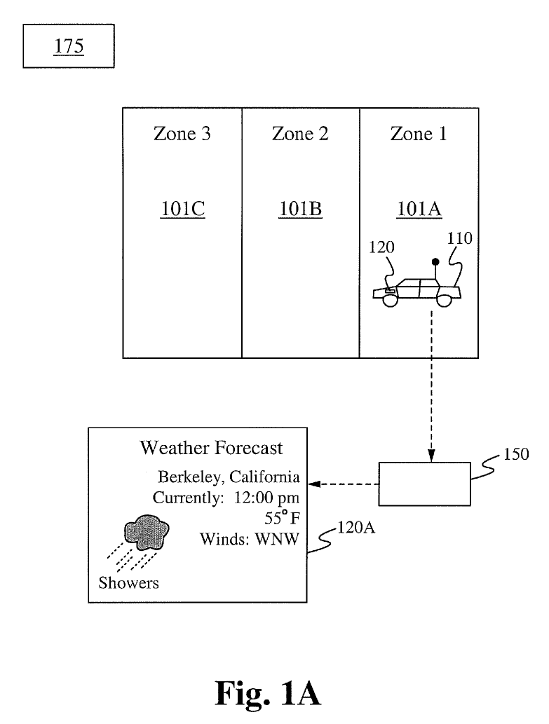

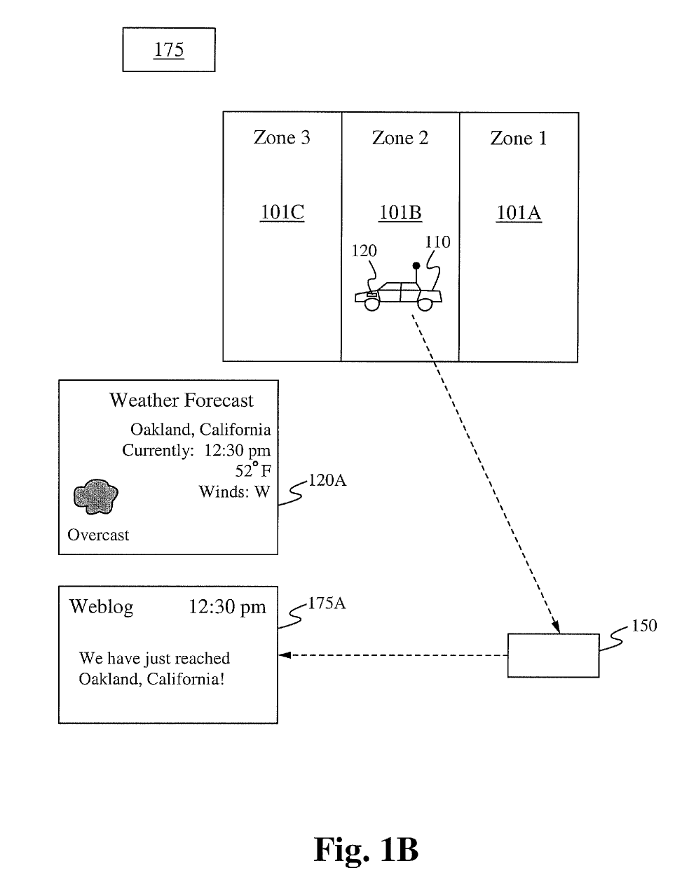

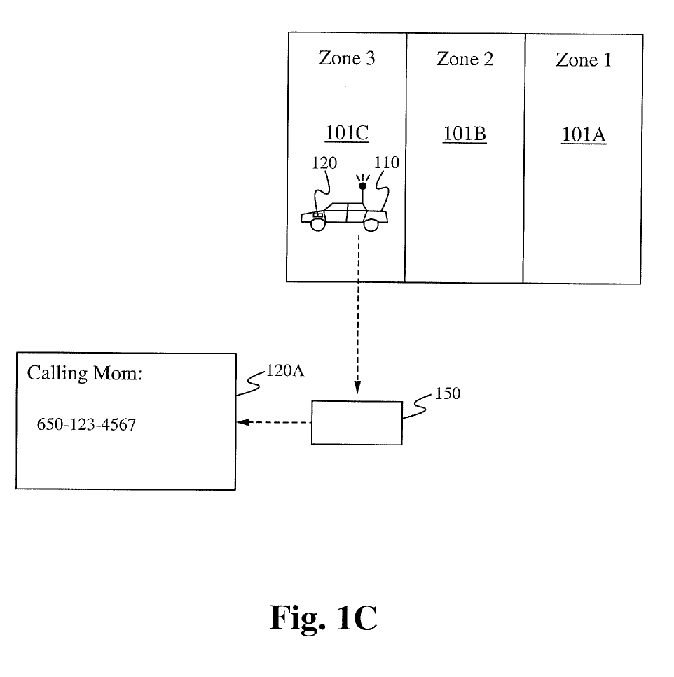

FIGS. 1A-C show an object, a car 110, tracked through zones 101A-C using a location server 150, in accordance with one embodiment of the present invention. As explained in more detail below, different processes are executed based on the presence of the car 110 within one of the zones 101A-C, as well as on any movement of the car 110 between the zones 101A-C. FIG. 1A shows several devices controlled by the location server 150, including a cellular telephone 120 within the car 110 and a Web server 175. The location server 150 and the Web server 175 are both outside the zones 110A-C, though one or both could be inside one of the zones 110A-C. The cellular telephone 120 has a display screen 120A, illustrated in the bottom left corner of FIGS. 1A and 1B, and the Web server 175 has a display screen 175A, illustrated in the bottom left corner of FIG. 1B.

As shown in FIG. 1A, when the location server 150 determines that the car 110 is within the zone 101A (Berkeley, Calif.), the location server 150 retrieves an up-to-the minute weather report for the zone 101A, formats it, and transmits it to the cellular telephone 120 (a destination) and thus the display 120A. Preferably, the location server 150 retrieves the weather report by accessing a Web site, such as AccuWeather.com®, or pager towers, as soon as it determines that the car 100 has entered the zone 101A.

As shown in FIG. 1B, when the location server 150 determines that the car 110 has entered the zone 101B, it executes two processes: the first transmits location data to a Weblog on the Web server 175, as shown on the display 175A; the second generates another weather report, this time for the zone 101B, Oakland, Calif.

As shown in FIG. 1C, when the location server 150 determines that the car 110 has entered the zone 101C, it executes a process that causes the cellular telephone 120 to call a predetermined number, such as to notify a family member that the owner of the cell phone 120 is about to arrive.

In the examples of FIGS. 1A-C, the processes that are executed (e.g., formatting an up-to-the minute weather report, updating a Weblog, and calling a telephone number) and their parameters (location data) are all dependent on the location of a tracked object, the car 110.

The car 110 can be tracked in any number of ways, such as by attaching a global positioning antennae to the car 110 or placing a similar functioning device inside the car 110. Alternatively, the cellular telephone 120 itself can be the tracked object, so long as it includes global positioning elements, such as those tracked by mobile telephone cell towers. In still other embodiments, the tracked object includes a beacon used by WiFi-enabled devices for identifying locations. Those skilled in the art will recognize other systems and methods for tracking the location and movement of an object.

While FIGS. 1A-C show rectangular, contiguous zones 101A-C, it will be appreciated that zones can be non-contiguous and can have other shapes, even arbitrary ones. In some embodiments, a user can define the shapes to fit the application at hand. Zones can be any size, such as those contoured to city blocks (e.g., rectangles spanning meters on each side), shopping districts (e.g., squares with sides measuring 1 mile), cities (e.g., circles with radiuses of 5 to 10 miles), counties, or even states.

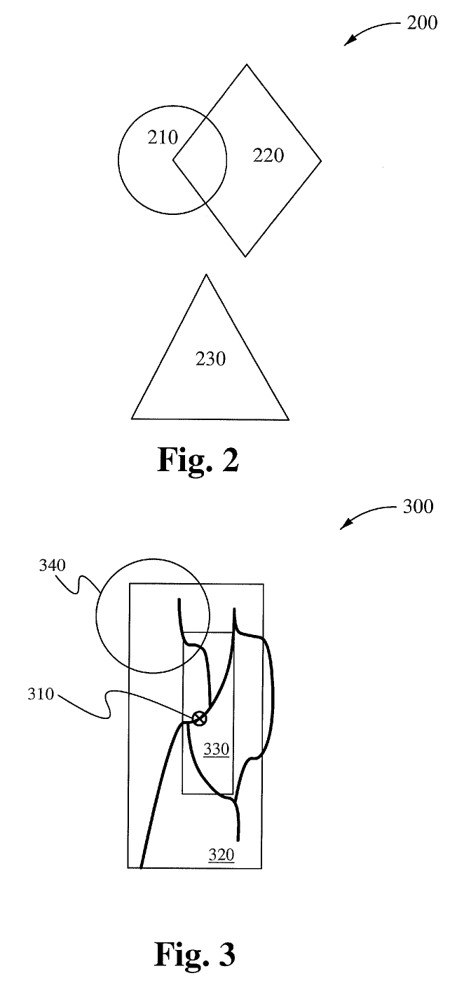

A history of the zones that a device (e.g., tracked object) has visited can also be used in defining when a process is triggered. One example is illustrated by FIG. 2, which shows a region 200 containing the zones 210, 220, and 230. The zones 210 and 220 overlap and are both non-contiguous to the zone 230. In this example, using a travel history (e.g. a record of zones that a device has previously entered), processes associated with the zones 210 and 220 are triggered only if the device has visited zone 230 first. Likewise, a process is triggered when the device is in zone 210, a different process is triggered when the device is in zone 220, and a third process is triggered if the device is in both (e.g., the intersection) of the zones 210 and 220.

FIG. 3 illustrates one example of dynamically generating data based on criteria that include a travel direction and a travel history. In this example, data is dynamically generated to alert drivers of a specific traffic alert, as it pertains to their current location and recently traversed path. Compound zone relationships can be used to trigger messaging in larger concentric zones, warning users that are approaching the zone containing the specific event. Many levels of specificity and dynamically created content can be generated which tailor the provided information precisely to the context of the user, and what traffic data would be most relevant to her. For example, combinations of concentric and neighboring zones, and the history of a device's recent path through those zones, can enable the delivery of a traffic warning to those approaching the traffic incident while not sending any alerts to users who are traveling away from the incident, even though multiple devices are currently contained in the same zone. FIG. 3 illustrates this example by showing a road network (curvy lines) over which a number of zones (zones 320, 330, and 340) have been placed.

In this example, a traffic incident occurs at location 310. The goal is to deliver a dynamically generated message (such as an audio file, or VOIP call, or some combination of audio file and map image) to drivers who may be affected by the traffic incident. Depending on where the drivers are, different information is delivered. Those drivers who are in zone 320, but not in zone 330, should be informed about alternate routes they may wish to take to avoid the traffic incident. The content transmitted to these drivers can include a map of alternate routes. Those drivers who are in zone 330 and are presumably already affected by the event should be informed about the location and severity of the traffic incident, and provided with an estimate of their travel time given the current conditions. Finally, drivers who are in zones 340 and 320, and who were recently in zone 330, can be assumed to be traveling away from the incident and do not need to be alerted at all.

Other criteria can be used to define how content is generated when a process is triggered. In accordance with some embodiments, a user's shopping history, travel history, travel plan, or any combination of these are used to dynamically generate content. For example, if a user has recently visited a zone (travel history) to purchase a tie (shopping history), when the user again visits the zone, content is generated listing stores within the zone offering sales on ties. As another example, the current weather is used to dynamically generate content. If it is unseasonably cold, when the user visits a zone, content is generated to display stores in or near the zone selling winter coats. As still another example, the current time and a shopping history are together used to dynamically generate content. If the current time is 12:00 p.m. and a user has previously visited movie theaters (e.g., “shopping history”) in the area (“travel history”), when the user enters a zone, a schedule listing movies that start between 12:30 p.m. and 1:00 p.m. is generated and transmitted to the user's cell phone.

In one embodiment, content includes an SMS message alerting a user that she has a message. The SMS message contains a link that, when opened, loads a Web page on the user's device. Content can be generated for access by a user in many different ways.

A location server in accordance with the present invention includes one or more of a zone database used to define the boundaries of zones, a process database that associates zones to processes, a purchase history database that associates users to purchases, a travel history database that associates objects with locations, and a search module used to dynamically generate content. These components are discussed in turn.

FIGS. 4-7 show databases in accordance with embodiments of the invention. FIG. 4 shows a zone database 400 containing rows 401-403, each correlating the boundaries of a zone with a zone identifier. The row 401 correlates a first set of boundaries (column 400A) with an identifier for zone 1 (column 400B). The row 402 correlates a second set of boundaries (column 400A) with an identifier for zone 3 (column 400B). As one example, if zone 1 has a rectangular shape, then the first set of boundaries is defined by four sets of (longitude, latitude) pairs, each defining a vertex of the rectangle. Different polygonal-shaped zones can be defined by a corresponding number of (longitude, latitude) pairs, each pair defining a vertex of the polygon. If zone 2 has a circular shape, the second set of boundaries can include a (longitude, latitude) pair corresponding to the center of the zone, followed by a single value corresponding to the radius of the zone. Zone boundaries can have any shape including circles, polygons, or even arbitrary shapes, and can be represented in different ways.

FIG. 5 shows a process database 500 having rows 501-511 and columns 500A-C, all in accordance with one embodiment of the invention. Each row of the process database 500 associates a zone (column 500A) with one or more processes (column 500B) and corresponding destination addresses (column 500C) to send the content or controls signals generated by the one or more processes. The row 501 associates zone 1 (column 500A) with a Weather Reporting program (column 500B), so that when an object enters zone 1, a process is triggered to access a weather information site for zone 1. The process formats the information and sends the resulting content to the destination shown descriptively as “Cellular Phone Address” (column 500C).

The elements shown in columns 500B and 500C are shown as descriptive text merely to simplify the drawings. Typically, the elements in column 500B are programs (e.g., executable programs, scripts, macros, pointers to any of these, and the similar elements) and the elements in column 500C are telephone numbers, Internet addresses, network appliance addresses, and other identifiers used to transmit content to a cell phone, Web server, and other destinations.

Still referring to FIG. 5, row 502 associates zone 2 with updating a Weblog (e.g., element 175 in FIG. 1B), row 503 associates zone 3 with initiating a call to a telephone number (e.g., FIG. 1C), row 504 associates zone 5 with an executable program (e.g., “ConditionalTrafficReport.exe”) for generating a traffic report (discussed below), row 510 associates zone 9 with dynamically generating a list of stores to shop for specific goods, and row 511 associates zone 10 with three processes: generating an updated traffic report, initiating a call to a specific telephone number, and turning ON a heater identified by an appliance address.

ConditionalTrafficReport.exe illustrates a program that defines criteria for determining when to trigger a process. As one example, a traffic report is generated only when a user is traveling north, that is, when he is entering zone A after just having passed through zone B. In pseudo-code, ConditionalTrafficReport.exe executes the algorithm:

```
if (object in zone A){
    if just passed through zone B, then call process Traffic Report
    else call process Weather Report
}
```

This pseudo-code illustrates that a process can in turn call one or more other processes.

It will also be appreciated that elements in the destination column (500C) can be dynamically determined, based on the context. As one example, an element in the destination column contains a pointer to a list of telephone numbers of those attending a scheduled meeting. When a tracked object enters a zone, each of the telephone numbers is sequentially called from a cellular telephone (e.g., 120, FIG. 1A) so that the user can inform them that he is running late. In this example, a single destination resolves to multiple destinations.

As another example, the destination is generated from a script:

```
if (time is between 10:00 a.m. and 12:00 p.m.)
    destination is telephone number 1 // call office to inform them that
meeting is over else if (time is after 5:00 p.m.)
    destination is telephone number 2 // call home
```

In these examples, the destination is determined by the zone entered, the time of day, or both.

Another example involves the having the triggered process look up the user who triggered the process and determine the address or phone number to send a message to dynamically. Thus, the process can be general to a large number of users and does not have a one-to-one mapping between processes and users.

Preferably, customized scripts and programs are offered to a user as part of extensible process and destination libraries. Processes selected from the process library can be stored in the process table 500 during system initialization of after. Destinations can similarly be selected from a destination library (now shown). It will be appreciated that logic and control for triggering processes and determining destinations can be customized to fit any application at hand.

FIG. 6 is a travel history database 600 in accordance with one embodiment of the invention. The database 600 has rows 601 and 602 and columns 600A and 600B, and associates a device ID (e.g., a cellular telephone number, a GPS identifier, or any other identifier of an object to be tracked) with locations visited and corresponding timestamp of each visit. Each element in the column includes a (location, date-time stamp) pair. For example, the row 601 indicates that a device having an identifier “ID1” (column 600A) visited zone 1 on day 1, time 1, visited zone 8 on day 1, time 2, and visited zone 9 on day 2, time 3 (column 600B). The days and times can be represented in any number of formats, such as “Sep. 23, 2009; 12:00 PM” or the number of seconds after Jan. 1, 1970, as used by the UNIX operating system, or using some other format.

Similarly, referring to the row 602, a device having the identifier “ID2” visited zone 20 on day 20, time 2, visited zone 21 on day 20, time 4, and visited zone 22 on day 21, time 3.

While the entries in the database 600 indicate when a device enters a zone, in other embodiments the entries also indicate when a device leaves a zone.

Elements in the database 600 can be used in many ways. As one example, it may be determined that a user associated with ID1 is more likely to shop in stores in zones 1, 8, and 9 and thus may be more interested in sales offered by those stores or others nearby. Embodiments of the invention can use this information to determine what content to generate and send to a destination. As another example, the zone and date-time stamps are used to determine the direction a driver is driving. Using this information, it can be determined whether a driver is heading toward or away from an accident and thus may want content (e.g., traffic reports and alternate routes) relating to it.

FIG. 7 is a shopping history database 700 in accordance with one embodiment of the present invention. The database 700 has rows 701 and 702 and columns 700A-C, and associates a device ID with shopping histories. For example, the row 701 associates a device having the device identifier “ID1” (column 700A) with Macy's® (column 700B) and the products “Mens Ties” and watches (column 700C), indicating that a user associated with device ID1 has previously bought Mens Ties and watches from Macy's. The row 702 associates a device having the device identifier “ID2” (column 700A) with Sears® (column 700B) and the products Tires and Tools (column 700C).

The databases 4-7 are just several examples of process, travel histories, and shopping histories. Preferably, the databases 4-7 are all relational databases having, for example, an identifier for a tracked object as the primary key. Those skilled in the art will recognize other structures and information for databases that can be used with embodiments of the invention.

FIG. 8 shows a location server 850 in accordance with one embodiment of the invention. The location server 850 is coupled, through the Internet 860, to a Web server 875 (e.g., similar to the Web server 175 of FIG. 1), an Internet accessible heater 870, and a cellular provider network 880. The location sever 850 includes a network interface card 830, which couples it to the Internet 860; a location module 810 for determining an object's location and movement from location information; a process execution module 815 for executing processes based on an object's location, movement, or both; a history database module 820; and a search module 825. The location module 810 contains the database 400 (FIG. 4), the process execution module 815 contains the database 500 (FIG. 5), and the history database module 820 contains the databases 600 and 700 (FIGS. 6 and 7, respectively).

FIGS. 9 and 10 are used to explain the operation of the components in accordance with one embodiment of the invention.

FIG. 9 shows the steps 900 of a method of triggering processes based on a location or movement of an object in accordance with embodiments of the invention. Referring to FIGS. 8 and 9, the method starts in the step 901, which includes initialization steps. For example, in the step 901, objects (e.g., using their device identifiers) are registered; the database 400 is populated to define zone boundaries; the database 500 is populated to associate zones with processes and processes with destinations; and the databases 600 and 700 are both populated. In alternative embodiments, the databases 300-700 are all capable of being updated dynamically, such as to reflect a recent purchase, a recent travel, and changing boundaries.

In the step 903, location information is transmitted from the cellular network provider (e.g., tracking the car 890 in FIG. 8), routed over the Internet 860, through the network interface card 830, and then received at the location module 810. In the step 905, the location module 810 accesses the database 400 to determine the location of an object 890 or its movement. In the step 907, the process execution module 815 uses the database 500 to correlate the location or movement with one or more corresponding processes and, in the step 909, executes the one or more corresponding processes. Generally, the processes dynamically generate content, format it, and transmit it to a destination (e.g., displaying an up-to-date weather report for a zone just entered) or transmit a control signal to a device (e.g., to turn the heater 870 ON when a car is approaching home).

In one embodiment, the process execution module 815 includes a transmission module that executes commands (e.g., SEND or POST) to forward content to the network interface card 830, from which it is sent over the Internet 860, to the cellular network provider 880, and over a cellular channel to the destination (e.g., a cellular telephone 892 in the car 890). In other embodiments, the process execution module 815 calls a separate transmission module (not shown) to transmit content to a destination. After the step 909, the method loops back to the step 903.

In one embodiment, formatting content includes packaging it in an Internet Protocol packet using a destination IP address. In other embodiments, formatting content includes packaging it in a voice message, wireless application program (WAP), or SMS message packet before transmitting it to a destination phone number or a Voice over IP address. All the destination addresses are stored (or are generated from information stored) in column 500C of FIG. 5 for the corresponding process called to generate the content.

In the step 909, the one or more processes can access the databases 600 and 700 or trigger the search module 825 to initiate an Internet search to dynamically generate content. FIG. 10 shows the steps 1000 of a method for dynamically generating content using an Internet search in accordance with one embodiment. First, in the step 1005, search terms (e.g., user purchase history, travel history, or both) are retrieved from one or both of the databases 600 and 700. Next, in the step 1010 an Internet search is executed. In the step 1015, the results of the search are parsed to retrieve content for transmission to a destination.

The steps 900 shown in FIG. 9 are merely exemplary. Those skilled in the art will recognize that the steps 900 can be performed in different orders, some steps can be deleted, and some can be added.

While FIG. 8 shows components of the location server 850 as a single system, it will be appreciated that the components can be distributed among any number of different computer systems. As but one example, the history database module 820 is on a server separate from the location server 850.

In the embodiment of FIG. 8, the location server 850 includes a computer-readable medium (not shown) that stores instructions corresponding to the steps 900 and 1000 and a processor 835 for executing these instructions. The computer-readable medium can be any type of memory including, but not limited to, solid state memory (e.g., RAM or ROM), hard drive memory, or other suitable media.

Again referring to FIG. 9, the location information received in the step 903 can be transmitted to the location server 850 in many different ways. As one example, the object transmits its location information at predetermined intervals or as soon as it enters a zone. Alternatively, the location server 850 polls the object for location information at predetermined intervals. In still other embodiments, the location sever 850 merely accesses a tracking database maintained by many cellular network providers. In these embodiments, zones can be mapped onto the zones defined by the cellular network provider databases. For example, a zone in accordance with the present invention can be defined by the combination of zones in the cellular network provider databases. Zones can be mapped to those defined in cellular network provider databases in many different ways.

It will also be appreciated that the locations can be determined in different ways. A location estimation can be represented by an exact latitude and longitude value, or it can be a location and accuracy estimate, or may be a set of values, such as visible WiFi hotspots, from which a location can be estimated. In one embodiment, a computer program executes on the device (e.g., tracked object) that acquires location estimation information from sensors on the device (such as a GPS antennae, WiFi hotspot identification, or cell tower triangulation), and forwards that location estimation to the location server 850. In another embodiment, the location estimation for the device is obtained from the communications network it is part of, such as the cellular network provider and/or providers of E911 (emergency response location) data. This data is also forwarded to the location server 850.

In one embodiment, a device's location is estimated and further computations on the reported location are performed to improve the estimation. Estimation fuses location information from multiple sources, such as using both the location reported by a GPS receiver on the device and the location information provided by cellular network provider to create a new location estimate which is more accurate than either source of information alone. Furthermore, the lack of data from certain available sources can be used to further constrain and optimize the information provided by some sources of location information. In one example, if the tracked device has the capability to sense WiFi hotspots, but does not currently see any, that lack of information can be used to further constrain its possible location as calculated by information from GPS and cellular tower triangulation.

A refinement on this process is to use measures of data certainty and probability of containment when calculating the physical relationship between a device and a zone. While a zone can be precisely located, most measurements of device location ultimately rely upon sensors that introduce error into the location estimate. As such, the location of the device is only accurate to some level of precision, which may vary between devices, over time, or by location. An example of this can be seen in the data provided by GPS receivers commonly embedded in many cell phones. Due to objects blocking the line of sight to the satellites used by GPS systems, or due to signals bouncing in complex multi-path patterns in an urban canyon, the accuracy of the reported location can vary widely from centimeter accuracy to many meters of accuracy. To accommodate these issues, embodiments of the invention describe the location of the device as a probability distribution. One embodiment of this distribution provides a center point and a radius of a concentric circle and assumes an even distribution within that circle. This embodiment uses such a distribution of location probability to calculate the likelihood of the device's containment (or exclusion) from a given zone. Different approaches to data certainty can be employed, such as confidence thresholds, to produce descriptions of a geographical relationship (inclusion, exclusion, entry, exit, etc.) between the zone and a device, approaches that are used by a location server to trigger process execution.

Given such a probabilistic description of location, in accordance with embodiments of the invention, a method determines the relationship between a given location and a zone. Specifically, the probability that the device is inside the zone is calculated, and tested against adjustable thresholds to declare inclusion in or exclusion from the zone.

In operation of one embodiment, the presence of a first device within a zone is determined using any location tracking system, including cellular networks, radio transmission, and the Internet, to name only a few. Content associated with the zone is dynamically generated. The content is encapsulated in a transmission packet that includes the address of a predetermined destination, such as a cell phone, a Web server, or an Internet appliance.

Examples of criteria for determining the content include the weather, time of day, season, upcoming holidays, a shopping history of an owner of the device, a travel history of zones previously visited by the owner, and traffic conditions. In one embodiment, databases containing shopping histories and travel histories are dynamically updated as soon as an object travels to a location or a user makes a purchase. Other criteria include an elapse of a predetermined time. For example, if an object does not move from a zone within a predetermined time, a process is called periodically, such as to generate updated weather reports.

Content can include local traffic reports, a list of local gas stations offering the cheapest gas along a travel route and within reach of the device's current location and travel range, and an email message sent to all attendees of a meeting scheduled to occur within the zone. Content is also generated by searching databases, internally provided or externally provided, such as databases controlled by third parties or business partners, or are publically available data retrieved from the Internet using published information request protocols. These data sources include current market conditions, maps, and traffic data, to name only a few of the types of stored information.

While FIGS. 1A-C show only a single location server, other embodiments include multiple locations severs. As one example, multiple location servers are distributed across a city, a county, a state, or a country. These location severs have replicated data and processes to support a user's travel throughout the different areas serviced by the location servers.

Furthermore, in other embodiments a single location server is able to support multiple users. For example, a single location server includes multiple process tables, purchase history databases, and travel history databases, one for each user. Or, in a other embodiments the users are held in a user database and processes are dynamically associated with the user who triggered the process. This enables a many-to-many association between process logic and users and their associated information (histories, phone numbers, preferences, etc).

As still another alternative, a location server retrieves location wirelessly rather than over the Internet. FIG. 11, for example, shows a location server 1100 that receives location information wirelessly from a car 1101 and transmits content directly to a device 1120 in the car 1101. In this embodiment, the location server 1100 includes an antenna for wirelessly receiving location information and transmitting generated content. In still other embodiments, a location server includes a combination of wireless transceivers and Internet interfaces.

It will be readily apparent to one skilled in the art that other modifications may be made to the embodiments without departing from the spirit and scope of the invention as defined by the appended claims.

We claim:

1. A system comprising:
a location module for tracking a location of an object;
a computer-readable medium containing computer-executable instructions for executing a process corresponding to the location or changes thereto and for transmitting content determined by the process to a destination.

2. The system of claim 1, further comprising a first database that correlates different locations to different processes.

3. The system of claim 1, further comprising a search module programmed to generate content.

4. The system of claim 3, wherein the search module is operatively coupled to a search engine.

5. The system of claim 3, wherein the search module is programmed to generate content based on a time, a date, weather conditions, traffic conditions, crime reports, market reports, or any combination thereof.

6. The system of claim 1, wherein the content comprises a travel advisory related to the location, a travel route related to the location, a map related to the location, a list of merchants within a predetermined distance of the location, or any combination of these.

7. The system of claim 1, wherein the destination is an email address, a telephone number, an Internet address, an appliance address, or a mobile telephone cell.

8. The system of claim 1, further comprising an interface for receiving location information for the object.

9. The system of claim 1, wherein the computer-executable instructions are also for triggering the process when the object enters or leaves a pre-defined zone.

10. The system of claim 1, further comprising a second database correlating the object to purchases, a travel history, a travel plan, or any combination thereof, wherein the search module is configured to generate content based on entries in the second database.

11. A method of communicating with a device comprising:
tracking a presence of an object within any of multiple zones; and
communicating with the device based on the presence or any changes thereto.

12. The method of claim 11, wherein communicating with the device comprises transmitting to the device rich media content, a voice message, audio content, video content, Web content, an email message, an SMS message, a command to control the device, or any combination thereof.

13. The method of claim 11, further comprising generating content by performing a search query corresponding to the presence or any changes thereto.

14. The method of claim 13, wherein the search query is based on a purchase history, a travel history, a travel plan, or any combination thereof.

15. The method of claim 13, wherein the search query is based on a time, a date, weather conditions, traffic conditions, crime reports, market reports, or any combination thereof.

16. The method of claim 11, wherein the tracking uses a cellular telephone network, a WiFi device, a geographic positioning system, or any combination thereof.

17. The method of claim 11, wherein an address of the device is determined dynamically.

18. The method of claim 11, wherein the tracking comprises estimating a location of the object within one of the multiple zones.

19. The method of claim 18, wherein estimating the location uses a probability distribution.

20. A location server comprising:
a location module for tracking a location of an object;
a process database for correlating locations to processes, wherein the processes are associated with zones;
a process execution module programmed to execute the processes to thereby generate content, and to transmit the content to a destination;
a purchase history database correlating an object to purchases;
a travel history database correlating an object to locations; and
a search module programmed to access the purchase history database and the travel history database to retrieve search term's and perform a search to generate content.

21. The location server of claim 20, further comprising a wireless transceiver for receiving location information and transmitting content.
